(19) United States
(12) Patent Application Publication
(10) Pub. No.: US 2026/0252501 A1
(43) Pub. Date: Aug. 27, 2026

(54) MEMORY CONTROLLER AND METHOD FOR MANAGING MEMORY ACCESS REQUESTS FROM A PLURALITY OF MASTERS

(71) Applicant: SAMSUNG ELECTRONICS CO., LTD., Suwon-si (KR)

(72) Inventors: Sampathkumar M. BALLARY, Bengaluru (IN); Ramesh Ganesh PATGAR, Bengaluru (IN); Aruna Sharnsunder LOHIYA, Bengaluru (IN); Vandana S., Bengaluru (IN); Karthik SRINIVASAN, Bengaluru (IN)

(73) Assignee: SAMSUNG ELECTRONICS CO., LTD., Suwon-si (KR)

(21) Appl. No.: 19/545,857

(22) Filed: Feb. 20, 2026

(30) Foreign Application Priority Data
Feb. 21, 2025 (IN) 202541015131
Feb. 16, 2026 (IN) 202644016850

(51) Int. Cl. G06F 13/16; G06F 11/34

(52) U.S. Cl. CPC G06F 13/161; G06F 11/3452; G06F 13/1663

(57) ABSTRACT

The present disclosure provides a memory controller for managing memory access requests from a plurality of masters. The memory controller may include a master decoding engine configured to decode memory access response traffic for the plurality of masters, a master latency storage configured to store a plurality of latency parameters, per-master first-in-first-out (FIFO) buffers configured to store a plurality of responses pending transmission to a respective master, a timer module configured to determine elapsed time and to accumulate latency error statistics, an adaptive weight generation engine configured to receive the latency error statistics and to generate one or more arbitration weights for each of the plurality of masters based on the latency error statistics, and a weighted arbiter configured to arbitrate between the plurality of responses ready for transmission from the per-master FIFO buffers.

### CROSS-REFERENCE TO RELATED APPLICATIONS

This application is based on and claims priority under 35 U.S.C. § 119 to Indian Provisional Application No. 202541015131, filed on Feb. 21, 2025, in the Indian Patent Office, the disclosure of which is incorporated by reference herein in its entirety.

### BACKGROUND

The present disclosure relates to System-on-Chip (SoC) architecture, and more particularly relates to a memory controller and method for managing memory access requests from a plurality of masters.

High-end System-on-Chip (SoC) architectures include numerous heterogeneous processing engines and masters that communicate through network-on-chip (NOC) interfaces. SoC architecture and performance validation aspects of SoC design have become key areas of execution to overcome post-silicon bottlenecks due to increasingly complex SoCs being designed for meeting end use case requirements.

Network-on-Chip (NOC) architectures and memory backbone designs have become complex due to various properties being integrated into the overall SoC space for enabling scenarios such as large language models, high resolution and high frame rate cameras and displays, high bandwidth communication protocols, and other demanding applications.

Referring to FIG. 1, a block diagram of a system-on-chip 100 depicting a conventional memory controller architecture according to prior art is illustrated. The system-on-chip 100 includes a plurality of masters, specifically a first master 102a, a second master 102b, a third master 102c, and a fourth master 102d. The first master 102a and the second master 102b are coupled to a first network-on-chip 103a, while the third master 102c and the fourth master 102d are coupled to a second network-on-chip 103b. The first network-on-chip 103a and the second network-on-chip 103b are connected to a main interconnect 104, which serves as a central communication pathway for routing memory access requests from the plurality of masters. The main interconnect 104 is divided into a front end portion and a back end portion. The back end portion of the main interconnect 104 is coupled to a conventional memory controller 106, which processes memory access requests received from the plurality of masters. The conventional memory controller 106 is connected to a DRAM interface 108, which performs asynchronous write and read operations to access data stored in a memory 110.

In conventional memory controller architectures, the memory controller and the DRAM interface generate response latencies for read and write access requests based on DRAM access patterns and intrinsic DRAM limitations. This results in random response latencies for each access request, providing limited control over the latency factor for responses transmitted back to the plurality of masters. Latency is a major factor that governs key performance indicators (KPIs) of any SoC architecture and performance validation aspect. When latency is not controllable, it limits the ability to identify architectural and performance-related issues present in the SoC.

Modern SoCs architectures include masters that interact via memory controllers. The masters are typically categorized into Real Time (RT) masters, where responses to requests are time-critical with respect to response latency, and non-real time masters, which have less stringent latency requirements. The priority assigned to each master type makes latency a deciding factor for validation. When the latency factor is not controllable at a per-master level independently for write or read access, it creates bottlenecks for validation.

Additionally, controllability of peak latency values over and above average latency values for every master for both write and read accesses independently is needed to validate the SoC architecture and performance aspects. Various conditions may cause latency values to surge to peak levels for particular periods, including multiple masters interacting simultaneously with high bandwidth requirements, and DRAM requirements for idle periods, such as self-refresh operations scheduled by the memory controller. The peak latency conditions are often reasons for failures observed in silicon implementations.

Accordingly, there is a need for a configurable memory controller to address the above-mentioned limitations.

### SUMMARY

This summary is provided to introduce a selection of concepts, in a simplified format, that are further described in the detailed description of the disclosure. This summary is neither intended to identify key or essential inventive concepts of the disclosure nor is it intended for determining the scope of the disclosure.

According to an aspect of the present disclosure, disclosed herein is a memory controller for managing memory access requests from a plurality of masters. The memory controller includes a master decoding engine configured to decode memory access response traffic for the plurality of masters using a configurable look-up table-based decoding logic. The memory controller includes a master latency storage configured to store a plurality of latency parameters for each of the plurality of masters. The memory controller includes per-master first-in-first-out (FIFO) buffers configured to store a plurality of responses pending transmission to a respective master associated with the plurality of masters. The memory controller includes a timer module configured to determine elapsed time for the plurality of responses relative to the plurality of latency parameters, and to accumulate latency error statistics for each of the plurality of masters, wherein the latency error statistics comprises a plurality of response packets across the plurality of masters. The memory controller includes an adaptive weight generation engine configured to receive the latency error statistics from the timer module and to generate one or more arbitration weights for each of the plurality of masters based on the latency error statistics for each of the plurality of masters. The memory controller includes a weighted arbiter configured to arbitrate between the plurality of responses ready for transmission from the per-master FIFO buffers based on the generated one or more arbitration weights.

According to an aspect of the present disclosure, disclosed herein is a system-on-chip configured to manage a plurality of memory access requests from a plurality of masters based on latency statistics. The system-on-chip includes the plurality of masters configured to generate the plurality of memory access requests. The system-on-chip includes a memory configured to store data accessible by the plurality of masters. The system-on-chip includes a memory controller coupled to the memory. The memory controller includes a master decoding engine configured to decode memory access response traffic for a plurality of masters using a configurable look-up table-based decoding logic. The memory controller includes a master latency storage configured to store a plurality of latency parameters for each of the plurality of masters. The memory controller includes per-master first-in-first-out (FIFO) buffers configured to store a plurality of responses pending transmission to a respective master associated with the plurality of masters. The memory controller includes a timer module configured to determine elapsed time for the plurality of responses relative to the plurality of latency parameters, and to accumulate latency error statistics for each of the plurality of masters, wherein the latency error statistics comprises a plurality of response packets across the plurality of masters. The memory controller includes an adaptive weight generation engine configured to receive the latency error statistics from the timer module and to generate one or more arbitration weights for each of the plurality of masters based on the latency error statistics for each of the plurality of masters. The memory controller includes a weighted arbiter configured to arbitrate between the plurality of responses ready for transmission from the per-master FIFO buffers based on the generated one or more arbitration weights.

According to an aspect of the present disclosure, disclosed herein is a method for managing memory access requests from a plurality of masters. The method includes decoding, by a master decoding engine, memory access response traffic for the plurality of masters using a configurable look-up table-based decoding logic. The method includes storing, by a master latency storage, a plurality of latency parameters for each of the plurality of masters. The method includes storing, by per-master first-in-first-out (FIFO) buffers, a plurality of responses pending transmission to a respective master associated with the plurality of masters. The method includes determining, by a timer module, elapsed time for the plurality of responses relative to the plurality of latency parameters. The method includes accumulating, by the timer module, latency error statistics for each of the plurality of masters, wherein the latency error statistics comprise a plurality of response packets across the plurality of masters. The method includes receiving, by an adaptive weight generation engine, the latency error statistics from the timer module. The method includes generating, by the adaptive weight generation engine, one or more arbitration weights for each of the plurality of masters based on the latency error statistics for each of the plurality of masters. The method includes arbitrating, by a weighted arbiter, between the plurality of responses ready for transmission from the per-master FIFO buffers based on the generated one or more arbitration weights.

To further clarify the advantages and features of the present disclosure, a more particular description of the disclosure will be rendered by reference to specific embodiments thereof, which are illustrated in the appended drawing. It is appreciated that these drawings depict only typical embodiments of the disclosure and are therefore not to be considered limiting its scope. The disclosure will be described and explained with additional specificity and detail, with the accompanying drawings.

### BRIEF DESCRIPTION OF DRAWINGS

These and other features, aspects, and advantages of the present disclosure will become better understood when the following detailed description is read with reference to the accompanying drawings in which like characters represent like parts throughout the drawings, wherein:

FIG. 1 illustrates, a block diagram of a system-on-chip depicting a conventional memory controller architecture according to prior art;

FIG. 2 illustrates an environment for implementing a system-on-chip for managing memory access requests from a plurality of masters, in accordance with an embodiment of the present disclosure;

FIG. 3 illustrates a block diagram of the system-on-chip for managing the memory access requests from the plurality of masters, in accordance with an embodiment of the present disclosure;

FIG. 4 illustrates a block diagram of a system-on-chip configured to manage the memory access requests from the plurality of masters, in accordance with an embodiment of the present disclosure;

FIG. 5 illustrates a block diagram of a system depicting a bus modelling index-based engine for managing the memory access requests from the plurality of masters, in accordance with an embodiment of the present disclosure;

FIG. 6 illustrates a response processing flow depicting the handling of memory access responses from DRAM through the memory controller, in accordance with an embodiment of the present disclosure;

FIG. 7 illustrates a block diagram of the memory controller configured to manage the memory access requests from the plurality of masters, in accordance with an embodiment of the present disclosure;

FIG. 8 illustrates a block diagram of a response processing system within the memory controller, in accordance with an embodiment of the present disclosure; and

FIG. 9 illustrates a flowchart depicting a method for managing the memory access requests from the plurality of masters, in accordance with an embodiment of the present disclosure.

Further, skilled artisans will appreciate that those elements in the drawings are illustrated for simplicity and may not have necessarily been drawn to scale. For example, the flow charts illustrate the method in terms of the most prominent steps involved to help improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

For the purpose of promoting an understanding of the principles of the disclosure, reference will now be made to the various embodiments, and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the present disclosure relates.

It will be understood by those skilled in art that the foregoing general description and the following detailed description are explanatory of the disclosure and are not intended to be restrictive thereof. Reference throughout this specification to “an aspect,” “another aspect,” or similar language means that a particular feature, structure, or characteristic described in connection with the embodiment is included in at least one embodiment of the present disclosure. Thus, appearances of the phrase “in an embodiment”, “in another embodiment”, and similar language throughout this specification may, but do not necessarily, all refer to the same embodiment. The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components preceded by “comprises . . . a” do not, without more constraints, preclude the existence of other devices or other sub-systems.

Embodiments of the present disclosure will be described below in detail with reference to the accompanying drawings.

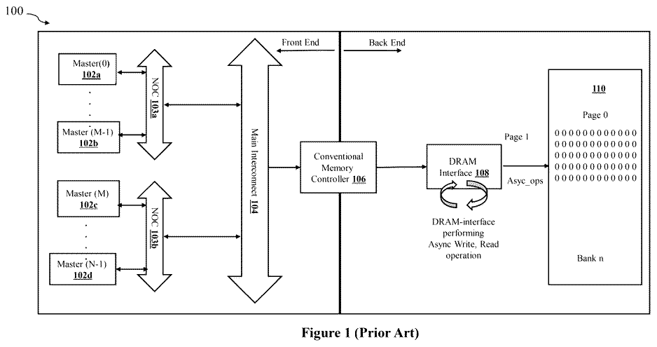

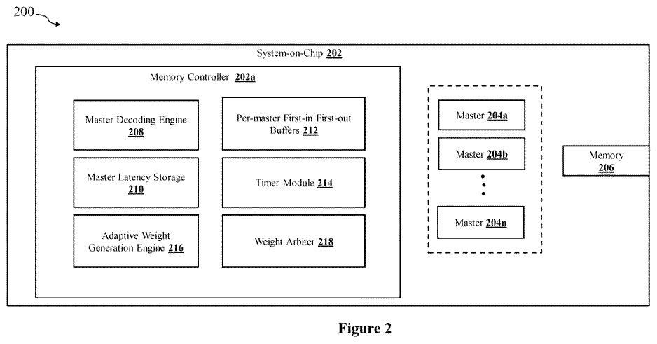

For the sake of clarity, the first digit of a reference numeral of each component of the present disclosure is indicative of the figure number, in which the corresponding component is shown. For example, reference numerals starting with digit “1” are shown at least in FIG. 1. Similarly, reference numerals starting with digit “2” are shown at least in FIG. 2. Further, similar reference numerals have been used to represent similar components in the figures.

FIG. 2 illustrates an environment 200 for implementing a system-on-chip 202 for managing a plurality of memory access requests from a plurality of masters 204a, 204b . . . 204n, in accordance with an embodiment of the present disclosure. The system-on-chip 202 may include a memory controller 202a that is coupled to a memory 206.

The memory controller 202a may include several components for managing the plurality of memory access requests (referred to as memory access requests for the sake of brevity) and responses. A master decoding engine 208 may be configured to decode memory access response traffic for the plurality of masters 204a, 204b . . . 204n (referred to as masters 204a, 204b . . . 204n for the sake of brevity) using a configurable look-up table-based decoding logic. In some aspects, the master decoding engine 208 may support decoding for up to 128 masters that generate traffic and are merged at a final interconnect. The look-up table-based decoding logic may be configurable according to the number of masters enabled in the environment 200.

As multiple response transaction coming from a memory interface for multiple request transactions, the master decoding engine 208 may be configured to segregate each response with the help of the look-up table and store the response in respective per-master first-in first-out (FIFO) buffers 212.

In an embodiment, a master latency storage 210 may be configured to store a plurality of latency parameters for each of the masters 204a, 204b . . . 204n. The plurality of latency parameters may include, for each of the masters, an average latency value, a peak latency value for each of a plurality of read operations, a plurality of write operations associated with the memory access requests, and the like. The master latency storage 210 may include configurable independent special function registers (SFRs) per master for write and read accesses, covering average and peak latency values.

The memory controller 202a may further include the per-master FIFO buffers 212 configured to store a plurality of responses pending transmission to a respective master associated with the masters 204a, 204b . . . 204n. Each of the plurality of responses may include a response packet corresponding to a respective request packet. Each of the plurality of responses may include data retrieved from the memory 206 in response to a read operation or an acknowledgement in response to a write operation.

A timer module 214 may be configured to determine elapsed time for the plurality of responses relative to the plurality of latency parameters and to accumulate latency error statistics for each of the masters 204a, 204b . . . 204n. The latency error statistics may include a plurality of response packets across the masters 204a, 204b . . . 204n. The timer module 214 may be used to drive latency generation logic and may include custom logic to capture statistics and generate probability factors used for adaptive analysis. In an embodiment, the latency error statistics may include a total number of the plurality of response packets received per master and a number of response packets per master for which a latency timeout has expired.

An adaptive weight generation engine 216 may be configured to receive the latency error statistics from the timer module 214. Further, the adaptive weight generation engine 216 may be configured to generate one or more arbitration weights (referred to as arbitration weights for the sake of brevity) for each of the masters 204a, 204b . . . 204n based on the latency error statistics for each of the masters 204a, 204b . . . 204n. In an embodiment, the adaptive weight generation engine 216 may be configured to determine a statistical measure indicative of relative latency performance for each of the masters 204a, 204b . . . 204n. The adaptive weight generation engine 216 may generate adaptive weights for each master and corresponding arbitration slots based on probabilistic statistics learned over time and degree of freedom exercised. For example the degree of freedom may include timeout counter value across the masters 204a, 204b . . . 204n, decide the arbitration weights based on frequency on which master is running.

A weight arbiter 218 may be configured to arbitrate between the plurality of responses ready for transmission from the per-master FIFO buffers 212 based on the generated arbitration weights. The arbitration weights may include one or more quantized values derived from one or more probability values corresponding to the statistical measure. An upper quantization limit and a lower quantization limit may bound the one or more quantized values. Further, the adaptive weight generation engine 216 may be configured to update the arbitration weights for each of the masters 204a, 204b . . . 204n based on a comparison of a latency error rate among the masters 204a, 204b . . . 204n. The weight arbiter 218 may implement a weighted slot machine arbiter across the masters 204a, 204b . . . 204n based on adapted weight inputs calculated based on dynamic system behavior.

The masters 204a, 204b . . . 204n may be configured to generate the memory access requests. In some aspects, the memory access response traffic may include a plurality of request packets generated by the masters 204a, 204b . . . 204n. Each of the plurality of request packets may include one or more of a read operation and a write operation to access data stored in the memory 206.

A feedback path may be configured to couple the adaptive weight generation engine 216 to the master latency storage 210. The feedback path may be configured to transmit a plurality of latency values from the adaptive weight generation engine 216 to the master latency storage 210 based on latency statistics to update latency error margins across the masters 204a, 204b . . . 204n.

The various components depicted in FIG. 2 may communicate with one another using wired or wireless communication protocols and may be configured to operate synchronously or asynchronously depending on the nature of the task.

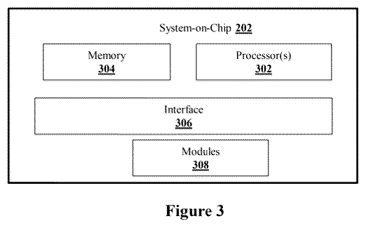

FIG. 3 illustrates a block diagram of the system-on-chip 202 for managing the memory access requests from the masters 204a, 204b . . . 204n, in accordance with an embodiment of the present disclosure. FIG. 3 has been explained in conjunction with FIG. 2 for the sake of brevity of the disclosure.

The system-on-chip 202 may include one or more processors 302 (hereinafter referred to as a processor 302), a memory 304, and an interface 306. In an exemplary embodiment, the processor 302 may be operatively coupled to the memory 304, the modules 306, and the interface 306.

In one embodiment, the processor 302 can be a single processing unit or several units, all of which could include multiple computing units. The processor 302 may be implemented as one or more microprocessors, microcomputers, microcontrollers, digital signal processors, central processing units, state machines, logic circuitries, and/or any devices that manipulate signals based on operational instructions. Among other capabilities, the processor 302 is adapted to fetch and execute computer-readable instructions and data stored in the memory 304.

In one embodiment, the processor 302 may be configured to perform the functions of the system-on-chip 202.

The memory 304 may be communicatively coupled to the processor 302. The memory 304 may be configured to store data and instructions executable by the processor 302. In one embodiment, the memory 304 may communicate via a bus within the system-on-chip 202. The memory 304 may include, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 304 may include a cache or random-access memory for the processor 302. In alternative examples, the memory 304 is separate from the processor 302, such as a cache memory of a processor, the system memory, or other memory. The memory 304 may be an external storage device or a database for storing data. The memory 304 may be operable to store instructions executable by the processor 302. The functions, acts, or tasks illustrated in the figures or described may be performed by the programmed processor 302 for executing the instructions stored in the memory 304. The functions, acts, or tasks are independent of the particular type of instruction set, storage media, processor, or processing strategy, and may be performed by software, hardware, integrated circuits, firmware, micro-code, and the like, operating alone or in combination. Likewise, processing strategies may include multiprocessing, multitasking, parallel processing, and the like. The memory 304 may further include a database to store the data. Further, the memory 304 may include an operating system for performing one or more tasks of the system-on-chip 202, as performed by a generic operating system in the communications domain.

For the sake of brevity, the architecture and standard operations of the processor 302 and the memory 304 are not discussed in detail. In one embodiment, the memory 304 may be configured to store the information as required by the processor 302 to perform the techniques described herein.

The modules 308, amongst other things, include routines, programs, objects, components, data structures, etc., which perform particular tasks or implement data types. The modules 308 may also be implemented as signal processor(s), state machine(s), logic circuits, and/or any other device or component that manipulates signals based on operational instructions. The modules 308 may be configured to one or more operations of the system 304 and/or the processor 302.

Further, the modules 308 can be implemented in hardware, instructions executed by a processing unit, or by a combination thereof. The processing unit can comprise a computer, the processor 302, a state machine, a logic array, or any other suitable device capable of processing instructions. The processing unit can be a general-purpose processor that executes instructions to cause the general-purpose processor to perform the required tasks, or the processing unit can be dedicated to performing the required functions.

Furthermore, the modules 308 may be implemented through the Artificial Intelligence (AI) model. A function associated with AI may be performed through the non-volatile memory, the volatile memory, and the processor.

The processor 302 may include one or a plurality of processors. At this time, one or a plurality of processors may be a general purpose processor, such as a Central Processing Unit (CPU), an Application Processor (AP), or the like, a graphics-only processing unit such as a Graphics Processing Unit (GPU), a Visual Processing Unit (VPU), and/or an AI-dedicated processor such as a Neural Processing Unit (NPU).

The processor 302 may control the processing of the input in accordance with a predefined operating rule or AI model stored in the non-volatile memory and the volatile memory. The predefined operating rule or artificial intelligence (AI) model is provided through training or learning.

Here, being provided through learning means that, by applying a learning algorithm to a plurality of learning data, a predefined operating rule or AI model of a desired characteristic is made. The learning may be performed in a device itself in which AI according to an embodiment is performed and may be implemented through a separate server/system.

The AI model may include a plurality of neural network layers and diffusion models. Each layer has a plurality of weight values and performs a layer operation through the calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

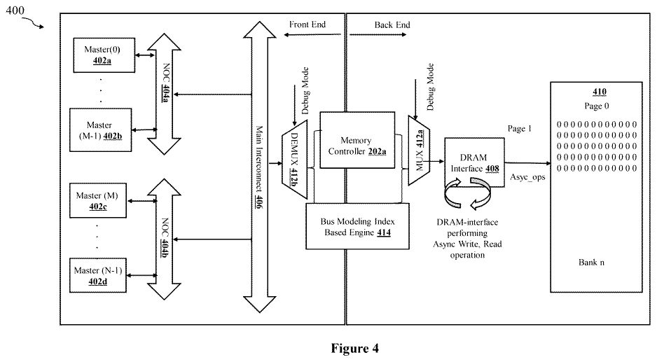

FIG. 4 illustrates a block diagram of a system-on-chip 400 configured to manage the memory access requests from the masters, in accordance with an embodiment of the present disclosure. The system-on-chip 400 may include a first master 402a, a second master 402b, a third master 402c, and a fourth master 402d. The first master 402a and the second master 402b may be coupled to a first network-on-chip 404a, while the third master 402c and the fourth master 402d may be coupled to a second network-on-chip 404b. The first network-on-chip 404a and the second network-on-chip 404b may be connected to a main interconnect 406, which facilitates communication between the masters and memory components.

The system-on-chip 400 may be divided into a front end section and a back end section. The front end section may include the memory controller 202a, which receives the memory access requests from the masters through the main interconnect 406. A demultiplexer 412b may be positioned between the main interconnect 406 and the memory controller 202a, and may be configured to route traffic based on a debug mode signal. The demultiplexer 412b may direct traffic either to the memory controller 202a or to a bus modeling index based engine 414.

The bus modeling index based engine 414 may be coupled to the memory controller 202a and may provide latency control capabilities for the memory access requests. The bus modeling index based engine 414 may enable per-master level controllability over latency parameters independently for write and read access operations.

The back end section may include a multiplexer 412a positioned between the memory controller 202a and a DRAM interface 408. The multiplexer 412a may be configured to receive a debug mode signal and select between outputs from the memory controller 202a and the bus modeling index-based engine 414. The DRAM interface 408 may be configured to perform asynchronous write and read operations.

The DRAM interface 408 may be coupled to a memory bank 410, which stores data accessible by the masters. The memory bank 410 may include multiple pages organized in a bank structure. The memory bank 410 may store data in a structured format represented by rows of binary values.

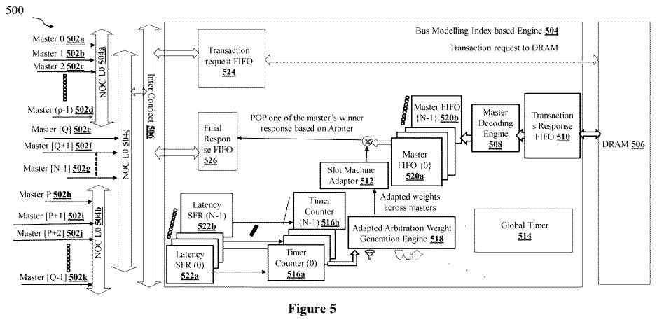

FIG. 5 illustrates a block diagram of a system 500 depicting a bus modelling index-based engine 504 for managing the memory access requests from the masters, in accordance with an embodiment of the present disclosure. The system 500 may include multiple masters organized across different network-on-chip interconnects. Master 0 502a, master 1 502b, master 2 502c, and master (p−1) 502d may be connected to NOC L0 interconnect 504a. Master [Q] 502e, master [Q+1] 502f, and master [N−1] 502g may be connected to NOC L0 504c. Master P 502h, master [P+1] 502i, master [P+2] 502j, and master [Q−1] 502k may be connected to NOC L0 504b.

The bus modelling index-based engine 504 may receive transaction requests from the masters through a transaction request FIFO 524 and may provide transaction requests to DRAM 506. The bus modelling index-based engine 504 may include a master decoding engine 508 configured to decode the memory access response traffic for the masters using a configurable look-up table based decoding logic. The bus modelling index based engine 504 may further include master FIFO 0 520a and master FIFO N−1 520b configured to store responses pending transmission to respective masters.

A transactions response FIFO 510 may interface with the DRAM 506 to receive response data. The bus modelling index based engine 504 may include latency SFR 522a and latency SFR 522b configured to store latency parameters for the masters. In some aspects, the latency parameters may include write average, write peak, read average, and read peak values for each master.

A timeout counter 0 516a and timeout counter N−1 516b may be provided to determine elapsed time for responses relative to the latency parameters. A global timer 514 may provide timing reference for the system 500. An adapted arbitration weight generation engine 518 may receive latency error statistics and generate arbitration weights for each master based on the latency error statistics. The adapted arbitration weight generation engine 518 may provide adapted weights across masters to a slot machine adaptor 512.

The slot machine adaptor 512 may arbitrate between responses ready for transmission from the master FIFOs based on the generated arbitration weights. A final response FIFO 526 may receive the arbitrated responses and transmit them to the appropriate masters through the NOC interconnects. The system 500 may enable per-master level controllability on latency parameters independently for write and read access operations.

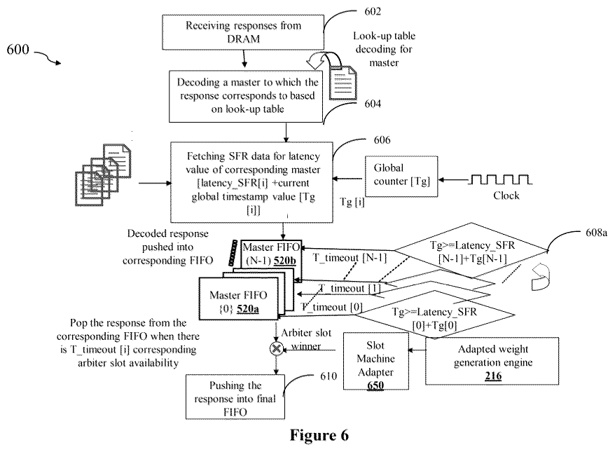

FIG. 6 illustrates a response processing flow 600 depicting the handling of memory access responses from DRAM through the memory controller 202a, in accordance with an embodiment of the present disclosure. The response processing flow 600 may begin with a response receiving step 602, where responses are received from the DRAM. A look-up table decoding for master may be associated with the response receiving step 602.

The response processing flow 600 may continue to a master decoding step 604 where a master to which the response corresponds is decoded based on a look-up table. Following the master decoding step 604, a latency data fetching step 606 may fetch SFR data for the latency value of the corresponding master, combining the latency SFR value with a current global timestamp value. A global counter may provide the timestamp value to the latency data fetching step 606, with the global counter being driven by a clock signal.

The decoded response may be pushed into a corresponding FIFO, with master FIFO 0 520a and master FIFO N−1 520b shown as per-master buffers for storing responses pending transmission. A timeout comparison logic 608a may determine when the global counter value meets or exceeds the sum of the latency SFR value and the timestamp value for each master, generating timeout signals for each master FIFO.

The response may be popped from the corresponding FIFO when there is a timeout signal and corresponding arbiter slot availability. An arbiter slot winner 610 may be configured to receive inputs from the master FIFOs and determine which response to transmit based on arbitration. A slot machine adapter 650 may be configured to interface with the arbiter slot winner 610 and receive adapted weights from the adaptive weight generation engine 216. The adaptive weight generation engine 216 may be configured to generate arbitration weights based on the timeout comparison logic 608a outputs. The response selected by the arbiter slot winner 610 may be pushed into a final FIFO for transmission.

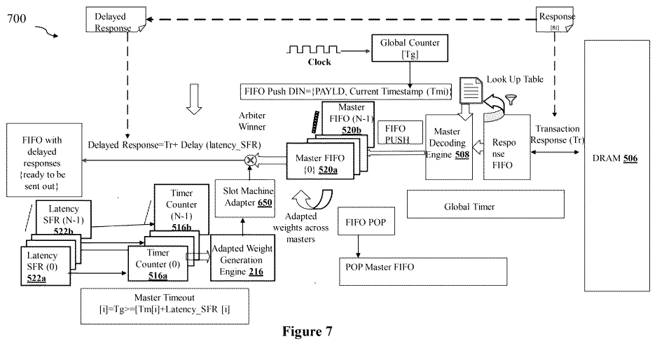

FIG. 7 illustrates a block diagram of the memory controller 700 configured to manage the memory access requests from the masters 204a, 204b . . . 204n, in accordance with an embodiment of the present disclosure. The memory controller 700 may include the master decoding engine 508, master FIFO 0 520a, master FIFO N−1 520b, latency SFR 522a, latency SFR 522b, timeout counter 0 516a, timeout counter N−1 516b, the adaptive weight generation engine 216, the slot machine adapter 650, and DRAM 506.

The memory controller 700 may be configured to receive a clock signal that drives a global counter providing a timestamp value Tg. Response traffic from the DRAM 506 may enter the memory controller 700 and pass through a look up table that feeds into the master decoding engine 508. The master decoding engine 508 may decode the incoming response traffic and direct responses to the appropriate per-master FIFO buffers. The master FIFO 0 520a and master FIFO N−1 520b may store responses pending transmission to their respective masters. Each response may be pushed into the appropriate master FIFO along with a payload and current timestamp Tmi.

The latency SFR 522a and latency SFR 522b may store latency parameters for each master. The timeout counter 0 516a and timeout counter N−1 516b may be coupled to their respective latency SFRs and master FIFOs. The timer counters may determine elapsed time for responses relative to the latency parameters stored in the latency SFRs. A master timeout condition may be triggered when the global timestamp Tg is greater than or equal to the sum of the master timestamp Tm[i] and the latency SFR value for that master, expressed as: Tg≥Tm[i]+Latency_SFR[i].

The adaptive weight generation engine 216 may be configured to receive latency error statistics from the timer counters and generate adapted weights across masters. The adapted weights may be provided to the slot machine adapter 650, which performs weighted arbitration to determine an arbiter winner among the responses ready for transmission from the per-master FIFO buffers. Slot[i]-based on adaptive weight generation. A global timer may be coupled to the FIFO POP operation that removes responses from the master FIFOs.

In an embodiment, the memory controller 700 may include a feedback path coupling the adaptive weight generation engine 216 to the master latency storage. The feedback path may be configured to transmit a plurality of latency values from the adaptive weight generation engine 216 to the master latency storage based on latency statistics to update latency error margins across the masters 204a, 204b . . . 204n.

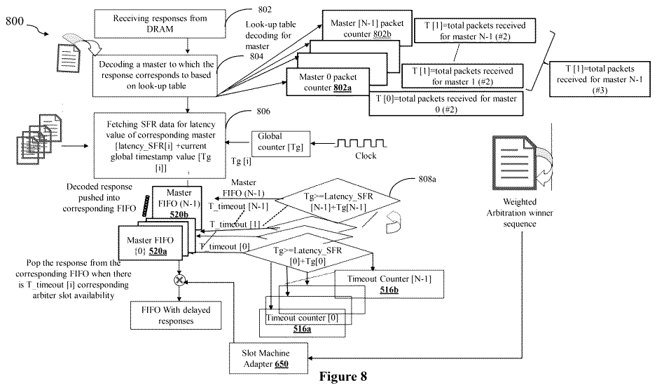

FIG. 8 illustrates a block diagram of a response processing system within the memory controller 202a, in accordance with an embodiment of the present disclosure. The response traffic 800 may enter the system and be processed by a look-up table decoding 802 mechanism. The look-up table decoding 802 may determine which master corresponds to each response based on configurable decoding logic.

The response processing system 800 may include a master 0 packet counter 802a and a master N−1 packet counter 802b, which track the total packets received for each respective master. The master 0 packet counter 802a may maintain a count T[0] representing total packets received for master 0, while the master N−1 packet counter 802b may maintain a count T[1] representing total packets received for master N−1.

The latency SFR data 804 may be fetched for the corresponding master, providing latency values that are combined with a current global timestamp value. A global counter 806 driven by a clock signal may provide the global timestamp value Tg [i] used for latency calculations.

The system may include per-master FIFO buffers, specifically master FIFO 0 520a and master FIFO N−1 520b, which store decoded responses pending transmission to their respective masters. Responses may be pushed into the corresponding FIFO after decoding and latency data association.

The timeout counter 0 516a and timeout counter N−1 516b may monitor elapsed time for responses in each master FIFO. The timeout counters may compare the global counter value Tg against timeout thresholds calculated as the sum of the latency SFR value and the timestamp when the response was received. When Tg is greater than or equal to the latency SFR value plus the stored timestamp for a given master, a timeout condition T_timeout[i] may be triggered.

Responses may be popped from the corresponding FIFO when there is a timeout condition and corresponding arbiter slot availability. The popped responses may be directed to a FIFO with delayed responses, which feeds into the slot machine adapter 650. The slot machine adapter 650 may perform weighted arbitration based on the weighted arbitration winner sequence 808a, which contains the adaptive weights generated for each master based on latency error statistics collected over time.

In some aspects, the adaptive weight generation engine 216 may be configured to determine a statistical measure based on a mean and a standard deviation of one or more intermediate factors. The one or more intermediate factors may be derived from product of (1) a ratio of latency timeout counts to a plurality of response packets for the respective master and (2) a total number of response packets across the plurality of masters 204a, 204b . . . 204n.

The arbitration priority weights generation logic for masters may depend on multiple system response behaviors. These may include: a total number of response packets received per master in a given interval that needs to be delayed, denoted as T[i]; a total number of response packets per master out of T[i] whose latency timeout expired, denoted as p[i]; an average error percentage of latency generated seen per master so far, denoted as e [i]; quantized error weights calculated per master, denoted as Qe[i]; a total number of response packets received across masters, denoted as t; a number of masters, denoted as N; quantized error factored number of response packets per master out of T[i] whose latency timeout expired, denoted as t[i]; an intermediate factor, denoted as To[i]; a mean of To[i], denoted as μ; a standard deviation, denoted as σ; a Z score, denoted as Z[i]; a probability based on Z table value for Z score, denoted as Prob[i]; adaptive quantized weights per master, denoted as Qw[i]; an upper limit of quantization factor, denoted as Uq; and a lower limit of quantization factor, denoted as Lq.

The latency timeout counter per master t[i] may be calculated as the product of the total number of response packets per master whose latency timeout expired p[i] and the quantized error weights calculated per master Qe[i], expressed as:

$$t [ i ] = p [ i ] \times Q e [ i ] .$$

The intermediate factor To[i] may be calculated as:

$$To [ i ] = \frac{t [ i ]}{T [ i ]} \times τ .$$

The mean u may be calculated as the mean of all To[i] values across the masters 204a, 204b . . . 204n:

$$μ = Mean ( To [ i ] ) .$$

The standard deviation σ may be calculated as:

$$σ = \sqrt{{\sum }_{i = 0}^{N - 1} {( T o [ i ] - μ )}^{2} / N} .$$

The Z score Z[i] may be calculated as:

$$Z [ i ] = \frac{T o [ i ] - μ}{σ} .$$

The probability Prob[i] may be determined by looking up the Z score Z[i] in a standard normal distribution Z-score table. The quantized adaptive weights for priority arbitration slots across masters Qw[i] may be calculated as:

$$Q w [ i ] = L q + ( U q - L q ) \times P r o b [ i ] ,$$

where Lq represents the lower limit of quantization, and Uq represents the upper limit of quantization.

In some aspects, the arbitration weights may be one or more quantized values derived from one or more probability values corresponding to the statistical measure, wherein an upper quantization limit and a lower quantization limit bound the one or more quantized values. The adaptive weight generation engine 216 may be configured to update the arbitration weights for each of the masters 204a, 204b . . . 204n based on a comparison of a latency error rate among the masters 204a, 204b . . . 204n.

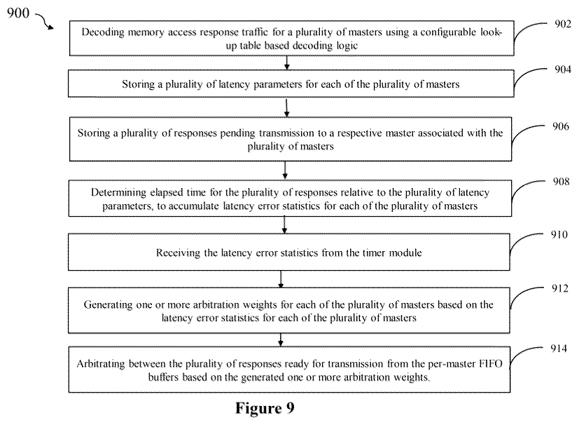

FIG. 9 illustrates a flowchart depicting a method 900 for managing the memory access requests from the masters 204a, 204b . . . 204n, in accordance with an embodiment of the present disclosure. The method 900 may begin with a step 902, where the memory access response traffic for the masters 204a, 204b . . . 204n is decoded using the configurable look-up table-based decoding logic.

The memory access response traffic may include the plurality of request packets generated by the masters 204a, 204b . . . 204n. Each of the plurality of request packets may include one or more of the read operation and the write operation to access data stored in the memory 206.

The method 900 may then proceed to a step 904, where the plurality of latency parameters for each of the masters 204a, 204b . . . 204n is stored. In some aspects, the plurality of latency parameters may include, for each of the masters 204a, 204b . . . 204n, the average latency value and the peak latency value for each of the plurality of read operations and the plurality of write operations associated with the memory access requests.

Following this, the method 900 may move to a step 906, where the plurality of responses pending transmission to a respective master associated with the masters 204a, 204b . . . 204n is stored. In some aspects, each of the plurality of responses may include the response packet corresponding to the respective request packet. Each of the plurality of responses may include the data retrieved from the memory 304 in response to the read operation or an acknowledgement in response to the write operation.

The method 900 may continue to a step 908, where elapsed time for the plurality of responses relative to the plurality of latency parameters is determined to accumulate latency error statistics for each of the masters 204a, 204b . . . 204n. The latency error statistics may comprise a plurality of response packets across the masters 204a, 204b . . . 204n.

The method 900 may then advance to a step 910, where the latency error statistics are received from the timer module 214. Subsequently, the method 900 may proceed to a step 912, where the arbitration weights for each of the masters 204a, 204b . . . 204n are generated based on the latency error statistics for each of the masters 204a, 204b . . . 204n.

The method 900 may conclude with a step 914, where arbitration between the plurality of responses ready for transmission from the per-master FIFO buffers is performed based on the generated arbitration weights. The method 900 illustrates a sequential process that enables adaptive weight-based arbitration for managing memory access responses across the masters 204a, 204b . . . 204n, where the arbitration weights are dynamically generated based on accumulated latency error statistics to improve response transmission scheduling. The arbitration weights may include one or more quantized values derived from one or more probability values corresponding to the statistical measure. An upper quantization limit and a lower quantization limit may bound the one or more quantized values.

Further, the method 900 may include determining the statistical measure indicative of relative latency performance for each of the masters 204a, 204b . . . 204n using the adaptive weight generation engine 216. Further, the method 900 may include determining, by the adaptive weight generation engine, the statistical measure based on a mean and a standard deviation of one or more intermediate factors. The one or more intermediate factors may be derived from a ratio of latency timeout counts to the plurality of response packets received for the respective master and the plurality of response packets across the masters 204a, 204b . . . 204n.

The method 900 may include updating the arbitration weights for each of the masters 204a, 204b . . . 204n based on the comparison of the latency error rate among the masters 204a, 204b . . . 204n.

Further, the disclosed techniques provide various advantages. For example, the configurable memory controller may enable per-master level controllability on latency parameters independently for write and read access, with the ability to introduce peak values over and above average values to mimic system behavior. The memory controller may achieve accurate modeling of memory controller and DRAM behavior with respect to latency for both write and read access, including peak latency addition over and above average values to model some of the DRAM intrinsic behavior in a highly non-deterministic system. The adaptive weight generation engine may provide auto-tuning ability to adjust the latency error margin across masters between what is expected and what is observed over dynamic system behavior with zero software intervention or external tuning agent. The memory controller may adapt itself in terms of various degrees of freedom, such as tuning its arbiter scheduling mechanism to meet latency requirements. The memory controller may support decoding for up to 128 unique masters across the system-on-chip independently for write and read requests. The configurable independent SFRs per master for write and read accesses, covering average and peak latency values, may enable precise control over latency parameters for each master. The weighted slot machine arbiter across the plurality of masters based on adapted weight inputs may enable fair and efficient arbitration based on dynamic system behavior and latency statistics.

In this application, unless specifically stated otherwise, the use of the singular includes the plural, and the use of “or” means “and/or.” Furthermore, the use of the terms “including” or “having” is not limiting. Any range described herein will be understood to include the endpoints and all values between the endpoints. Features of the disclosed embodiments may be combined, rearranged, omitted, etc., within the scope of the disclosure to produce additional embodiments. Furthermore, certain features may sometimes be used to advantage without a corresponding use of other features.

It is understood that terms including “unit” or “module” at the end may refer to the unit for processing at least one function or operation and may be implemented in hardware, software, or a combination of hardware and software.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

What is claimed is:

1. A memory controller for managing memory access requests from a plurality of masters, the memory controller comprising:
a master decoding engine configured to decode memory access response traffic for the plurality of masters using a configurable look-up table-based decoding logic;
a master latency storage configured to store a plurality of latency parameters for each of the plurality of masters;
per-master first-in-first-out (FIFO) buffers configured to store a plurality of responses pending transmission to a respective master associated with the plurality of masters;
a timer module configured to determine elapsed time for the plurality of responses relative to the plurality of latency parameters, and to accumulate latency error statistics for each of the plurality of masters, wherein the latency error statistics comprise a plurality of response packets across the plurality of masters;
an adaptive weight generation engine configured to receive the latency error statistics from the timer module and to generate one or more arbitration weights for each of the plurality of masters based on the latency error statistics for each of the plurality of masters; and
a weighted arbiter configured to arbitrate between the plurality of responses ready for transmission from the per-master FIFO buffers based on the generated one or more arbitration weights.

2. The memory controller as claimed in claim 1, wherein the plurality of latency parameters comprises an average latency value and a peak latency value for each of a plurality of read operations and write operations associated with a plurality of memory access requests.

3. The memory controller as claimed in claim 1, wherein the memory access response traffic comprises a plurality of request packets generated by the plurality of masters,
wherein each of the plurality of request packets comprises one or more of a read operation and a write operation to access data stored in a memory.

4. The memory controller as claimed in claim 1, wherein each of the plurality of responses comprises a response packet corresponding to a respective request packet,
wherein each of the plurality of responses comprises data retrieved from a memory in response to a read operation or an acknowledgement in response to a write operation.

5. The memory controller as claimed in claim 1, wherein the adaptive weight generation engine is further configured to determine a statistical measure indicative of relative latency performance for each of the plurality of masters.

6. The memory controller as claimed in claim 1, wherein the adaptive weight generation engine is further configured to determine a statistical measure based on a mean and a standard deviation of one or more intermediate factors,
wherein the one or more intermediate factors are derived from a product of (i) a ratio of latency timeout counts to a plurality of response packets for the respective master and (ii) a total number of response packets across the plurality of masters.

7. The memory controller as claimed in claim 6, wherein the one or more arbitration weights are one or more quantized values derived from one or more probability values corresponding to the statistical measure,
wherein an upper quantization limit and a lower quantization limit bound the one or more quantized values.

8. The memory controller as claimed in claim 1, wherein the adaptive weight generation engine is further configured to update the one or more arbitration weights for each of the plurality of masters based on a comparison of a latency error rate among the plurality of masters.

9. The memory controller as claimed in claim 1, wherein the memory controller further comprises a feedback path coupling the adaptive weight generation engine to the master latency storage,
wherein the feedback path is configured to transmit a plurality of latency values from the adaptive weight generation engine to the master latency storage based on latency statistics to update latency error margins across the plurality of masters.

10. A system-on-chip configured to manage a plurality of memory access requests from a plurality of masters based on latency statistics, the system-on-chip comprising:
the plurality of masters configured to generate the plurality of memory access requests;
a memory configured to store data accessible by the plurality of masters;
a memory controller coupled to the memory, wherein the memory controller comprises:
a master decoding engine configured to decode memory access response traffic for the plurality of masters using a configurable look-up table-based decoding logic;
a master latency storage configured to store a plurality of latency parameters for each of the plurality of masters;
per-master first-in-first-out (FIFO) buffers configured to store a plurality of responses pending transmission to a respective master associated with the plurality of masters;
a timer module configured to determine elapsed time for the plurality of responses relative to the plurality of latency parameters, and to accumulate latency error statistics for each of the plurality of masters, wherein the latency error statistics comprises a plurality of response packets across the plurality of masters;
an adaptive weight generation engine configured to receive the latency error statistics from the timer module and to generate one or more arbitration weights for each of the plurality of masters based on the latency error statistics for each of the plurality of masters; and
a weighted arbiter configured to arbitrate between the plurality of responses ready for transmission from the per-master FIFO buffers based on the generated one or more arbitration weights.

11. A method for managing memory access requests from a plurality of masters, the method comprising:
decoding, by a master decoding engine, memory access response traffic for the plurality of masters using a configurable look-up table-based decoding logic;
storing, by a master latency storage, a plurality of latency parameters for each of the plurality of masters;
storing, by per-master first-in-first-out (FIFO) buffers, a plurality of responses pending transmission to a respective master associated with the plurality of masters;
determining, by a timer module, elapsed time for the plurality of responses relative to the plurality of latency parameters;
accumulating, by the timer module, latency error statistics for each of the plurality of masters, wherein the latency error statistics comprise a plurality of response packets across the plurality of masters;
receiving, by an adaptive weight generation engine, the latency error statistics from the timer module;
generating, by the adaptive weight generation engine, one or more arbitration weights for each of the plurality of masters based on the latency error statistics for each of the plurality of masters; and
arbitrating, by a weighted arbiter, between the plurality of responses ready for transmission from the per-master FIFO buffers based on the generated one or more arbitration weights.

12. The method as claimed in claim 11, wherein the plurality of latency parameters comprises an average latency value and a peak latency value for each of a plurality of read operations and write operations associated with a plurality of memory access requests.

13. The method as claimed in claim 11, wherein the memory access response traffic comprises a plurality of request packets generated by the plurality of masters,
wherein each of the plurality of request packets comprises one or more of a read operation and a write operation to access data stored in a memory.

14. The method as claimed in claim 11, wherein each of the plurality of responses comprises a response packet corresponding to a respective request packet,
wherein each of the plurality of responses comprises data retrieved from a memory in response to a read operation or an acknowledgement in response to a write operation.

15. The method as claimed in claim 11, wherein the method further comprises:
determining, by the adaptive weight generation engine, a statistical measure indicative of relative latency performance for each of the plurality of masters.

16. The method as claimed in claim 11, wherein the method further comprises:
determining, by the adaptive weight generation engine, a statistical measure based on a mean and a standard deviation of one or more intermediate factors,
wherein the one or more intermediate factors are derived from a product of (i) a ratio of latency timeout counts to a plurality of response packets for the respective master and (ii) a total number of response packets across the plurality of masters.

17. The method as claimed in claim 16, wherein the one or more arbitration weights are one or more quantized values derived from one or more probability values corresponding to the statistical measure,
wherein an upper quantization limit and a lower quantization limit bound the one or more quantized values.

18. The method as claimed in claim 11, wherein the method further comprises:
updating, by the adaptive weight generation engine, the one or more arbitration weights for each of the plurality of masters based on a comparison of a latency error rate among the plurality of masters.

19. The method as claimed in claim 11, wherein the method further comprises:
transmitting, from the adaptive weight generation engine using a feedback path, a plurality of latency values to the master latency storage based on latency statistics to update latency error margins across the plurality of masters, the feedback path coupling the adaptive weight generation engine to the master latency storage.

20. The method as claimed in claim 16, wherein generating the one or more arbitration weights comprises: calculating a Z-score for each of the plurality of masters by subtracting the mean from the one or more intermediate factors and dividing by the standard deviation; and determining one or more probability values corresponding to the Z-score based on a standard normal distribution.
